(19) United States
(12) Patent Application Publication
(10) Pub. No.: US 2015/0170117 A1
(43) Pub. Date: Jun. 18, 2015

(54) METHOD AND SYSTEM FOR AUTOMATED CONDITIONAL TRUST INCOME DISBURSEMENT

(71) Applicant: Robert Friedman, Laguna Hills, CA (US)

(72) Inventor: Robert Friedman, Laguna Hills, CA (US)

(21) Appl. No.: 14/103,962

(22) Filed: Dec. 12, 2013

(51) Int. Cl. G06Q 20/10; G06Q 50/18

(52) U.S. Cl. CPC G06Q 20/10; G06Q 50/186

(57) ABSTRACT

Described herein is method and system for automated conditional trust income disbursement. The method involves receiving, by a computing device, instructions implementing trust provisions, the instructions identifying a res, at least one beneficiary, and at least one conduct condition, determining whether the beneficiary has satisfied the at least one conduct condition, and allocating trust income. The method may also include receiving data from the beneficiary or third party and comparing the data to the at least one conduct condition, and disbursing the income either to the at least one beneficiary or to an alternate recipient, responsive to the determination.

### TECHNICAL FIELD

Embodiments disclosed herein relate generally to methods and systems for managing financial instruments, and in particular to control of income disbursements pursuant to those instruments.

### BACKGROUND ART

Trusts are among the most flexible and useful financial instruments a person can use to provide for the financial well-being of his or her loved ones. A trust typically is managed and possessed by a person or entity, known as a trustee, who is distinct from the person, called a beneficiary, on whose behalf the trust is created. As a result, a person establishing a trust may specify a wide range of provisions to protect the trust property and control the manner of its investment and of the distribution of its income. Of particular note is the “spendthrift” trust, in which the person forming the trust attempts to protect the beneficiary from the effects of the beneficiary's own weaknesses when it comes to managing money. For instance, a spendthrift trust will commonly put the trust property beyond the reach of the beneficiary while allowing the beneficiary to receive income generated by investing that property. In some cases, the trust may also specify that the income will only be available if the beneficiary has followed certain behavioral requirements. Although some systems exist that allow for computer-assisted creation of trusts, no currently existent solution takes full advantage of computer technology to effect the will of the trust settlor.

Therefore, there remains a need for a system that evaluates conditions set by the trust creator, and distributes trust income as dictated by those conditions.

### SUMMARY OF THE EMBODIMENTS

A method is disclosed for automated conditional trust income disbursement. The method includes receiving, by a computing device, at least one instruction implementing trust provisions including a res, at least one beneficiary, and at least one conduct condition, determining, by the computing device, whether the at least one beneficiary has satisfied the at least one conduct condition, and allocating, by the computing device, a benefit, responsive to the determination.

In a related embodiment of the method, receiving also involves receiving an instruction identifying at least one account to which to allocate the benefit. In an additional embodiment, receiving further includes receiving an instruction specifying a date for the allocation of the benefit. In still another embodiment, receiving also includes providing, to a settlor, a plurality of potential trust provisions with corresponding instructions and receiving, from the settlor, a selection of at least one of the plurality of potential trust provisions and the instruction corresponding to that at least one potential trust provision. In yet another embodiment, receiving further involves receiving, from a settlor, textual data describing trust provisions and converting the textual data into at least one instruction. Receiving textual data also involves receiving, from the settlor, a scanned document containing an image of at least one trust provision and extracting, from the scanned document, textual data describing trust provisions, in another embodiment.

In a related embodiment, determining includes receiving data from the at least one beneficiary and comparing the received data to the at least one conduct condition. According to another embodiment, determining further includes receiving data from an additional computing device and comparing the received data to the at least one conduct condition. In an additional embodiment, determining further involves determining that no data relevant to the conduct condition has been received.

In another embodiment, determining further includes determining that the at least one beneficiary has met the at least one conduct condition, and allocating further involves automatically disbursing the benefit to the at least one beneficiary. Disbursing also involves performing an electronic fund transfer to an account possessed by the at least one beneficiary in a related embodiment. Under another related embodiment, disbursing also includes printing a negotiable instrument and shipping the negotiable instrument to the at least one beneficiary. In an additional embodiment determining also involves determining that the beneficiary has not met the at least one conduct condition, and allocating trust income further includes disbursing the benefit to an alternate entity. Determining further includes determining that the beneficiary has not met the conduct condition, and allocating trust income also includes reinvesting trust income in the res, in another embodiment. In another embodiment, receiving additionally involves receiving at least one res distribution instruction, and allocating the benefit further involves distributing a portion of the res as specified by the res distribution instruction.

Still another embodiment, in which receiving further involves receiving an instruction implementing a trust termination condition, further includes determining that the trust termination condition has occurred and terminating the trust. In an additional embodiment, receiving further includes receiving at least one trust income distribution instruction, and allocating the benefit also involves disbursing a portion of the trust income as specified by the trust income distribution instruction. In yet another embodiment, receiving the trust income distribution instruction also includes receiving an instruction that specifies what proportion of the trust income is to be disbursed, and disbursing additionally includes disbursing that proportion of the trust income. Receiving the trust income distribution instruction further involves receiving an instruction that specifies a fixed amount of trust income to be disbursed, and disbursing further includes disbursing that fixed amount, in an additional embodiment.

A system is also disclosed for automated conditional trust income disbursement. The system includes a computing device. The system also includes a receiver, executing on the computing device, and configured to receive at least one instruction implementing trust provisions including a res, at least one beneficiary, and at least one conduct condition. The system additionally includes an evaluator, executing on the computing device, and configured to determine whether the at least one beneficiary has satisfied the at least one conduct condition. The system also includes a benefit allocator, executing on the computing device, and configured to allocate the trust income, responsive to the determination.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. It should be understood, however, that neither the system nor the method is limited to the precise arrangements and instrumentalities shown.

FIG. 1A is a schematic diagram depicting a computing device;

FIG. 1B is a schematic diagram depicting a web application platform;

FIG. 2 is a schematic diagram depicting an embodiment of the disclosed system; and

FIG. 3 is a flow chart illustrating one embodiment of the disclosed method.

### DETAILED DESCRIPTION OF SPECIFIC EMBODIMENTS

Definitions. As used in this description and the accompanying claims, the following terms shall have the meanings indicated, unless the context otherwise requires.

A “computing device” is defined as including personal computers, laptops, tablets, smart phones, and any other computing device capable of supporting an application as described herein.

A device or component is “coupled” to a computing device if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet).

“Data entry devices” is a general term for all equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components.

A “scanner” is any component or set of components coupled to a computing device that record images on an electronic image sensor, for instance using a digital camera, video camera, platen scanner, or drum scanner. Persons of ordinary skill in the art will be familiar with digital cameras that may be attached to computers to transfer images, cameras that operate while attached to computers (i.e. “webcams”), and the near-ubiquitous built-in cameras that come with mobile phones. Scanners that may be used with computers or other computing devices have existed for decades, and are known to persons of ordinary skill in this invention's technical field. Furthermore, persons of ordinary skill in the art will be aware of cameras that can be attached to computers to transfer video that they have captured, digital video cameras that operate while attached to computers (i.e. “webcams”), and the digital cameras capable of capturing video that are built into many mobile phones.

A computing device's “display” is a device coupled to the computing device, by means of which the computing device can display images. Display include without limitation monitors, screens, television devices, and projectors.

To “maintain” data in the memory of a computing device means to store that data in that memory in a form convenient for retrieval as required by the algorithm at issue, and to retrieve, update, or delete the data as needed.

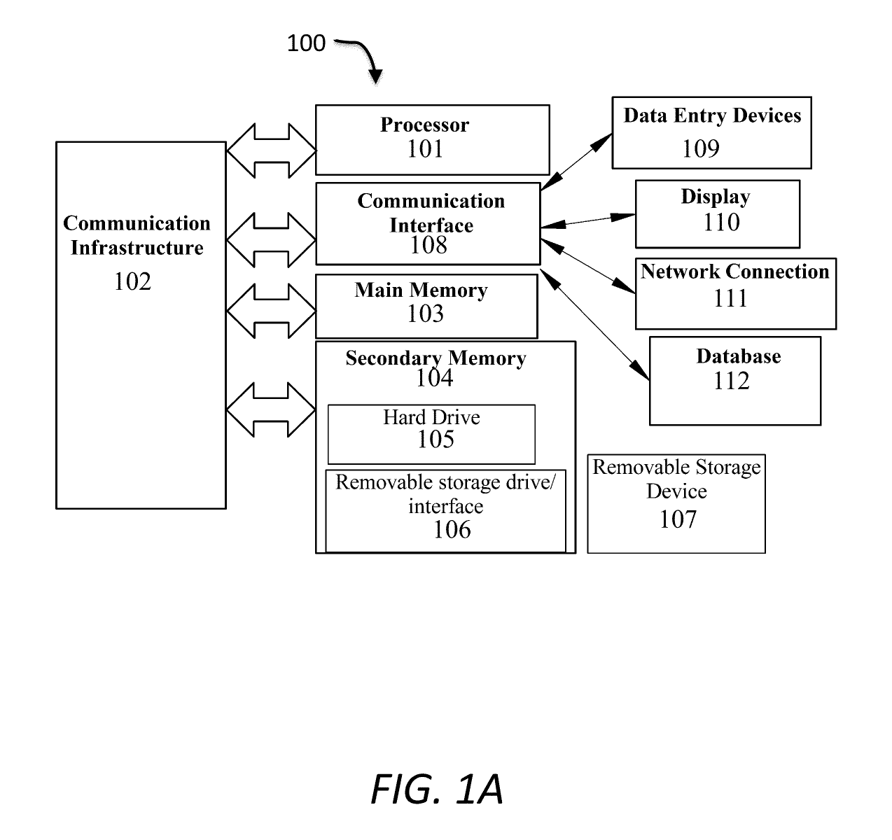

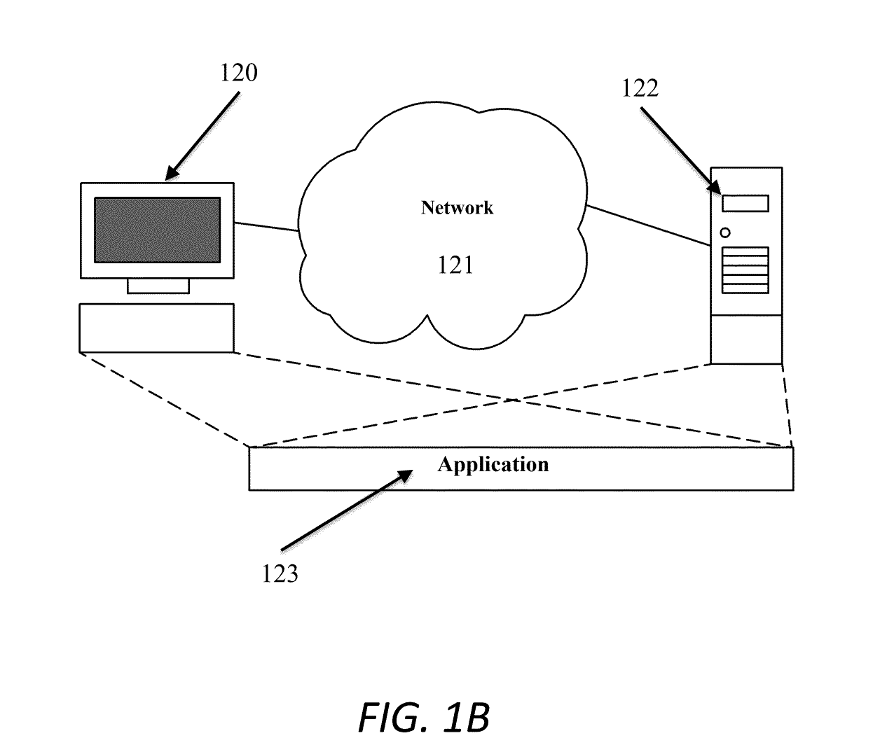

Some embodiments of the disclosed system and methods will be better understood by reference to the following comments concerning computing devices. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. The communications interface in the system embodiments discussed herein facilitates the coupling of the computing device with data entry devices 109, the device's display 110, and network connections, whether wired or wireless 111. It should be noted that each of these devices may be embedded in the device itself, attached via a port, or tethered using a wireless technology such as BLUETOOTH®.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily comprise facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The systems may be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an electronic device as described above. The client device 120 connects via some form of network connection to a network 121, such as the Internet. The network 121 may be any arrangement that links together electronic devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an electronic device as described above, or a set of electronic devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud. However, the web application must inherently involve some programming on each device.

Many electronic devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an electronic device to operate as a web application client 120. Thus, as a general matter, web applications 123 require some computer program configuration of both the client device (or devices) 120 and the server 122. The computer program that comprises the web application component on either electronic device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

Embodiments of the disclosed system and methods allow a settlor to establish provisions of a trust, including conditions governing the conduct of beneficiaries, and enter them on an automated system that will enforce those provisions on the settlor and trustees' behalf. The system can verify beneficiaries' conformance with trust provisions automatically by communicating with entities possessing relevant data, potentially accomplishing a far closer watch on beneficiary behavior than would be possible for trustees alone to accomplish.

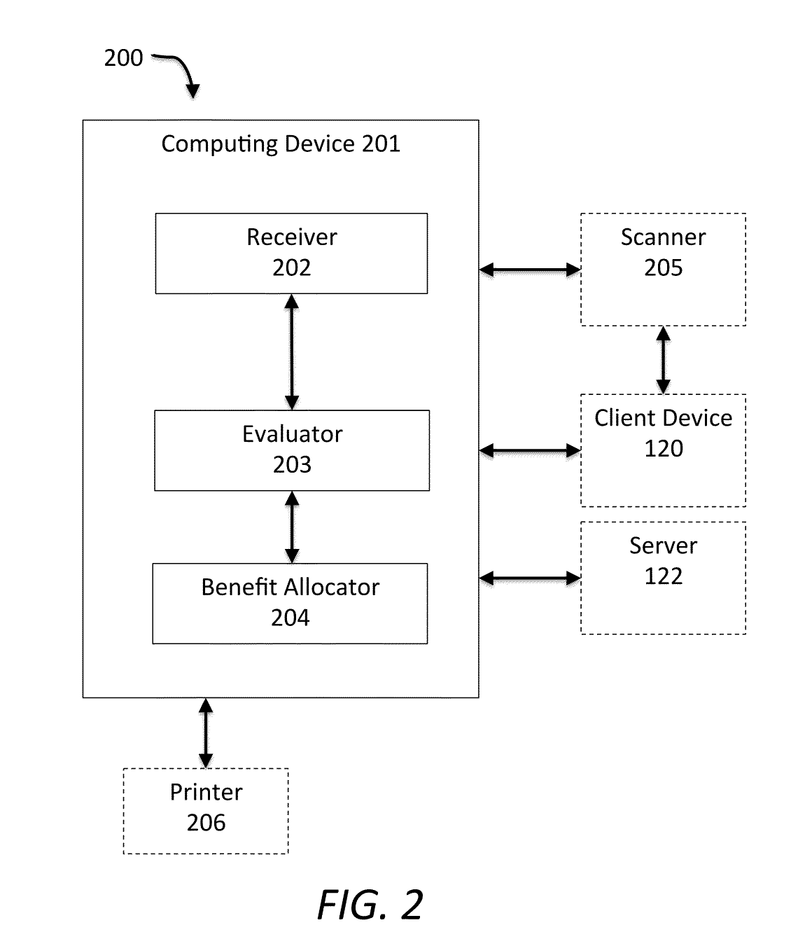

FIG. 2 depicts a system for automated conditional trust income disbursement. As an overview, the system includes a computing device 201. Executing on the computing device 201 is a set of algorithmic steps that may be conceptually described as creating a receiver 202, an evaluator 203, and a benefit allocator 204. The organization of tasks into those three components solely reflects a categorization of the tasks to be performed, and does not dictate the architecture of particular implementations of the system 200. For instance, in some embodiments of the system 200, the steps performed are executed by various objects in an object-oriented language, but the objects divide the tasks in a different manner than the above division. In other embodiments, the algorithmic steps exist as a set of instructions in a non-object oriented language, with no explicit separation of responsibility for steps into distinct components at all. Persons skilled in the art will recognize the existence of a broad variety of programming approaches that could cause the computing device 201 to perform the algorithmic steps.

In some embodiments, the system and methods disclosed herein administer trusts. In an embodiment, a trust is a legal arrangement created by a person or entity called a “settlor,” whereby one person or entity, known as a “trustee,” possesses property, known as a “res,” for the benefit of one or more persons or entities, called the “beneficiary” or “beneficiaries.” The trust document, which is the document that establishes the provisions controlling the trust, may describe the property contained in the res. The trust document may name a trustee; if the trustee does not accept the duties of the trust, the trust may be reassigned to another trustee. The trust document may describe the duties of the trustee. In some embodiments, the duties of the trustee describe how the trustee must manage the property. The duties of the trustee may require the trustee to make certain investment decisions. The duties of the trustee may require the trustee to maintain a certain balance of assets; for instance, the trustee may be required to keep and manage a certain proportion of the res as real property, another proportion as equity investment, and another proportion as debt investment. The duties of the trustee may require the trustee to take certain investment actions under certain circumstances, such as changing the balance of property in the res in response to market fluctuations.

In some embodiments, the return on investment of the res is called the “trust income.” The duties of the trustee may direct the trustee to allocate the trust income in a particular way. In some embodiments, the trust documents establish a regular period for the allocation of trust income, such as once a month or once a year. The duties of the trustee may direct the trustee to distribute the income to each beneficiary; the proportion given each beneficiary may be described in the trust document as well. The duties of the trustee may direct the trustee to reinvest a certain proportion of the trust income in the res. In some embodiments, the trust document establishes rules for the trust income that depend on the amount of trust income available at a particular point; for instance, there may be a minimum quantity that must be disbursed to beneficiaries, so that a smaller proportion of the trust income is reinvested when the trust income for a particular period has decreased. In other embodiments, the trust documents set forth conditions that must be satisfied before a particular allocation of the trust income or res may be performed. Some conditions may be temporal conditions, which require a certain amount of time to elapse before a particular income allocation commences, or before a particular portion of the res is distributed. For instance, a temporal condition may require that trust income be disbursed to a particular beneficiary starting after a particular number of days have elapsed since the trust was executed. Another temporal condition may require that a beneficiary reach a particular age prior to receiving trust income. Other conditions may be event-based conditions, such a requirement that the settlor be deceased prior to the disbursement of income to beneficiaries.

Some conditions may be conduct conditions, which condition the disbursement of trust income or distribution of trust property to a particular beneficiary on performance, by the beneficiary, of a particular act or omission. As a non-limiting example of an act, the conduct condition may require the beneficiary to marry prior to the commencement of disbursements of income to that beneficiary. Another non-limiting example may require the beneficiary to attend college. The conduct condition may require the beneficiary to complete a certain number of college classes. The conduct condition may require the beneficiary to complete a certain number of high school classes. The conduct condition may require the beneficiary to be employed. The conduct condition may require the beneficiary to attend therapy sessions, such as “alcoholics anonymous” meetings. The conduct condition may require the beneficiary to attend religious services. The condition may require the beneficiary to meet fitness requirements. In some embodiments, the conduct condition requires that the beneficiary take and pass a drug test within a certain time prior to the scheduled disbursement. A conduct condition may require omissions by the beneficiary; for instance, the beneficiary may receive income under the conduct condition only if the beneficiary has not been arrested within a certain time period prior to the scheduled disbursement. The condition may require that the beneficiary not be convicted of a crime within a certain time period prior to the scheduled disbursement.

Referring to FIG. 2 in more detail, the system 200 includes a computing device 201. In some embodiments, the computing device 201 is a computing device 100 as disclosed above in reference to FIG. 1A. In one embodiment, the computing device 201 is a server 122 as disclosed above in reference to FIG. 1B. The computing device 201 may communicate with one or more additional servers 122. The computing device 201 and the one or more additional servers 122 may coordinate their processing to emulate the activity of a single server 122 as described above in reference to FIG. 1B. The computing device 201 and the one or more additional servers 122 may divide tasks up heterogeneously between devices; for instance, the computing device 201 may delegate the tasks of the receiver 202 to an additional server 122. In some embodiments, the computing device 201 functions as a client device 120 as disclosed above in reference to FIG. 1B.

The receiver 202 executes on the computing device 201. The receiver 202 in some embodiments is a computer program as described above in reference to FIG. 1A. In some embodiments, the receiver 202 communicates with one or more client devices 120 via a network, as disclosed above in reference to FIG. 1B. In additional embodiments, the receiver 202 communicates with one or more servers 122 via a network, as disclosed above in reference to FIG. 1B. The receiver 202 may also communicate with a scanner 205. In some embodiments, the receiver is configured to receive at least one instruction implementing trust provisions including a res, at least one beneficiary, and at least one conduct condition.

The evaluator 203 executes on the computing device 201. The evaluator 203 in some embodiments is a computer program as described above in reference to FIG. 1A. In some embodiments, the evaluator 203 communicates with one or more client devices 120 via a network, as disclosed above in reference to FIG. 1B. In additional embodiments, the evaluator 203 communicates with one or more servers 122 via a network, as disclosed above in reference to FIG. 1B. The evaluator 203 may also communicate with a scanner 205. In some embodiments, the evaluator 203 configured to determine whether the at least one beneficiary has satisfied the at least one conduct condition.

The system 200 may include a benefit allocator 204, executing on the computing device. The benefit allocator 204 in some embodiments is a computer program as described above in reference to FIG. 1A. In some embodiments, the benefit allocator 204 communicates with one or more client devices 120 via a network, as disclosed above in reference to FIG. 1B. In additional embodiments, the benefit allocator 204 communicates with one or more servers 122 via a network, as disclosed above in reference to FIG. 1B. The benefit allocator 204 may also communicate with a printer 206. In some embodiments, the benefit allocator 204 is configured to allocate the trust income, responsive to the determination.

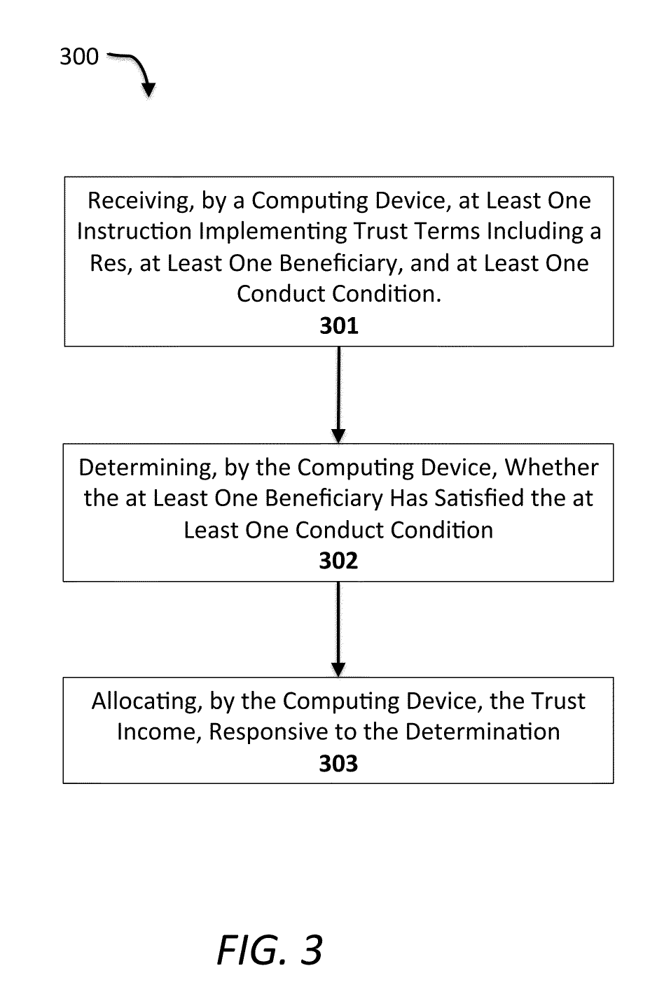

FIG. 3 illustrates some embodiments of a method 300 for automated conditional trust income disbursement. The method 300 includes receiving, by a computing device, at least one instruction implementing trust provisions including a res, at least one beneficiary, and at least one conduct condition (301). The method includes determining, by the computing device, whether the at least one beneficiary has satisfied the at least one conduct condition (302). The method 300 includes allocating, by the computing device, a benefit, responsive to the determination (303).

Referring to FIG. 3 in greater detail, and by reference to FIG. 2, the receiver 202 receives at least one instruction implementing trust provisions including a res, at least one beneficiary, and at least one conduct condition (301). The instruction concerning the res may also include data permitting the computing device 201 to communicate with entities managing particular portions of the res. The instruction may permit the computing device 201 to communicate with a server 122 operated by the entity managing a portion of the res; the instruction may include data necessary to authorize the computing device to transfer assets from that entity to another entity. The instruction concerning the beneficiary may contain identifying information of the at least one beneficiary, such as a name, date of birth, or social security number belonging to the at least one beneficiary. In some embodiments, the instruction concerning the beneficiary includes a mailing address for the at least one beneficiary. The instruction may include data necessary to transfer assets from the entity to another entity. In some embodiments, the receiver 202 receives the at least one instruction by receiving an instruction identifying at least one account to which to allocate the benefit. For instance, the at least one instruction may list an account number to which the computing device 201 may wire an electronic transfer. The instruction may include a routing number. The instruction may include any data necessary to print a valid negotiable instrument from the entity instructing payment to another entity that proffers the negotiable instrument. In some embodiments, the receiver 202 receives an instruction specifying a date for an allocation of the benefit.

In some embodiments, the receiver 202 receives the at least one instruction by providing, to a settlor, a plurality of potential trust provisions with corresponding instructions and receiving, from the settlor, a selection of at least one of the plurality of potential trust provisions and the instruction corresponding to that at least one potential trust provision. The receiver 202 may provide a web page to a client device 120 operated by the settlor. The receiver 202 may provide data to an application operating on the client device 120. The receiver 202 may provide data to a display coupled to the computing device 201. The receiver 202 may present the data as a list of options for the settlor to select; for instance, the client device 120 may provide one or more drop-down lists from which the settlor may select the provisions the settlor may desire. The receiver 202 may present the potential trust provisions in other graphical forms as well, including fixed lists, tables, buttons, links, and text fields in which the settlor may enter displayed options. In some embodiments, when the settlor selects an optional provision, the receiver 202 automatically records the selection of the instruction corresponding to that provision. The instruction corresponding to the selected provision may be a variable value that activates a particular block of code. The instruction corresponding to the selected provision may be a block of code. The instruction may provide a particular function executing on the computing device 201 with parameters. The instruction may populate an abstract data type operating on the computing device 201. The instruction may populate global variables stored on the computing device 201.

In some embodiments, the receiver 202 receives the at least one instruction by receiving, from a settlor, textual data describing trust provisions and converting the textual data into at least one instruction. The receiver 202 may convert the textual data into at least one instruction by mapping words or phrases to particular instructions stored in memory accessible to the computing device 201. For instance, the computing device 201 may contain in its memory a table mapping words to instructions; the table may map “benefitting,” “beneficiaries,” and “for the benefit of” to an instruction identifying beneficiaries, with the result that a sentence or clause containing any of those phrases would be interpreted by the receiver 202 as an instruction identifying the beneficiaries, and the subject of the sentence or clause as the name or names of the beneficiaries. In some embodiments, the receiver 202 displays the instructions thus derived to the settlor, permitting the settlor to alter them by selecting or deselecting provisions as provided above. For instance, the receiver 202 may present the settlor with a list of beneficiaries obtained by following the stored instruction regarding beneficiary selection; the settlor may deselect a beneficiary erroneously identified by the receiver 202.

In some embodiments, the receiver 202 receives textual data by receiving, from the settlor, a scanned document containing an image of at least one trust provision and extracting, from the scanned document, textual data describing trust provisions. The receiver 202 may extract the textual data using character recognition software. Once the receiver has extracted the textual data, it may proceed as described above for textual data submitted by a settlor.

The method includes determining, by the computing device, whether the at least one beneficiary has satisfied the at least one conduct condition (302). Where the at least one beneficiary is more than one beneficiary, the evaluator 203 may determine that a first beneficiary has satisfied conduct condition regarding the first beneficiary, while a second beneficiary has failed a conduct condition regarding the second beneficiary. A conduct condition regarding one beneficiary may differ from a conduct condition regarding another; for example, a beneficiary who is in high school may have a conduct condition requiring school attendance, while an older beneficiary who has had substance abuse problems may have a conduct condition requiring negative drug tests. In some embodiments, a beneficiary has multiple conduct conditions. For instance, one beneficiary may have a condition requiring class attendance, and a second condition requiring negative drug tests. In some embodiments, the evaluator 203 receives data from the at least one beneficiary, and compares the received data to the at least one condition. In one embodiment, the evaluator 203 receives textual data entered by the at least one beneficiary. In another embodiment, the evaluator 203 receives a document scanned by the at least one beneficiary. In another, the evaluator 203 receives an electronic file from the at least one beneficiary. The data may be submitted by the beneficiary via a client machine 120. The data may be submitted by the beneficiary via data entry devices coupled to the computing device 201 as described above in reference to FIG. 1A. The data submitted by the at least one beneficiary may be verifiable. For instance, the at least one beneficiary may submit an electronic file that contains safeguards to prevent tampering. There may be a third party with which the evaluator 203 can check to verify the accuracy of the information submitted by the at least one beneficiary. In some embodiments, the evaluator 203 always checks with the third party to verify the at least one beneficiary's information. In other embodiments, the evaluator 203 checks with the third party at unpredictable intervals, for instance by following the outcome of a pseudo-random number generator. The evaluator 203 may check with the third party as directed by a user; for instance, a trustee may enter an instruction on the computing device 201 directing the evaluator 203 to transmit a query to the third party to verify the beneficiary's information.

In some embodiments, the evaluator 203 determines whether the at least one beneficiary has satisfied the at least one conduct condition by receiving data from an additional computing device and comparing the received data to the at least one conduct condition. A third party in a position to report on the conduct of the at least one beneficiary may operate the additional computing device. For instance, where the conduct condition requires the at least one beneficiary to attend high school classes regularly, the additional computing device may be a server 122 operated by the high school that the at least one beneficiary currently attends, and the data it sends may be the at least one beneficiary's attendance records over the period to be evaluated. As another example, where the conduct condition requires the at least one beneficiary to submit to and pass a drug test every month, the drug testing company may operate a server 122 that can transmit the test results to the evaluator 203. In other embodiments, a third party may send a document containing data concerning the at least one beneficiary's conduct to a user of the computing device 201, who enters the document into the computing device 201 via a scanner. In some embodiments, the third party otherwise informs a user operating the computing device 201; for example, the third party may call a user of the computing device 201 on the telephone.

In some embodiments, the evaluator 203 determines whether the at least one beneficiary has satisfied the at least one condition by determining that no data relevant to the conduct condition has been received. As an example, the conduct condition may specify that the trust income be disbursed to a beneficiary unless a notification from the beneficiary's high school indicates that the beneficiary has gotten into disciplinary trouble; in that case, a lack of data concerning the beneficiary's comportment at high school is sufficient for the evaluator 203 to determine that the beneficiary has satisfied that condition. Alternatively, where a condition requires a beneficiary to pass a drug test once a month, if no drug test results are conveyed to the evaluator 203, the evaluator 203 may conclude that the beneficiary failed to take a drug test, and thus failed to satisfy the condition precedent to receiving the trust income.

The benefit allocator 204 allocates the trust income, responsive to the determination (303). In some embodiments, the evaluator 203 determines that the at least one beneficiary has met the at least one conduct condition, and benefit allocator 204 automatically disburses the benefit to the at least one beneficiary. In one embodiment, the benefit allocator 204 performs an electronic fund transfer to an account possessed by the at least one beneficiary. In another embodiment the benefit allocator 204 prints a negotiable instrument, and ships the negotiable instrument to the at least one beneficiary. A “negotiable instrument” may be any unconditional promise or order to pay a fixed amount of money, with or without interest or other charges described in the promise or order. Negotiable instruments may include, without limitation, checks, notes, money orders, cashiers checks, and certificates of deposit. For instance, the benefit allocator 204 may print a check payable to the at least one beneficiary, and print an envelope in which an operator can mail the money order to the beneficiary. In other embodiments, the benefit allocator 204 activates a machine that inserts the negotiable instrument into an envelope, seals the envelope, and applies postage to it.

In some embodiments, the evaluator 203 determines that the beneficiary has not met the at least one conduct condition, and the benefit allocator 204 disburses the benefit to an alternate entity. The at least one instruction implementing trust provisions may specify one or more alternate entities to which the trust income may be conveyed. As a non-limiting example, the alternate entity may be another beneficiary. The alternate entity may be a set of other beneficiaries. The alternate entity may be a charitable institution. The alternate entity may be a business. The alternate entity may be another trust. The benefit allocator 204 may disburse the income to the alternate entity using any method described above for disbursing income to a beneficiary. In some embodiments, the evaluator 203 determines that the beneficiary has not met the conduct condition, and benefit allocator 204 reinvests trust income in the res. Trust income may be calculated as set forth in more detail below. The receiver 202 may also receive instructions applying the trust income to other uses, such as allocation of trust income to pay for attorneys' fees in the case that a beneficiary challenges the trust provisions. Where there is more than one beneficiary, and some beneficiaries have passed their conditions while others have failed, the benefit allocator 204 may disburse to the passing beneficiaries the benefits scheduled to be given to the passing beneficiaries while allocating the benefits scheduled for the non-passing beneficiaries to an alternate destination as described above. Failure of one of multiple conditions imposed on a single beneficiary may cause the benefit allocator 204 to disburse a partial payment of the benefit to a beneficiary; for instance, if the beneficiary is subject to N conduct conditions, and the total quantity of the benefit scheduled for that beneficiary if the beneficiary passes all N conditions is X, and the beneficiary has failed M of the conditions, the benefit allocator 204 may pay the beneficiary X*(1-M/N). Alternatively, failure of any of multiple conditions may cause the benefit allocator 204 to pay the failing beneficiary none of the benefit; the benefit allocator 204 may then allocate the benefit to an alternative recipient as described above.

In some embodiments, the receiver 202 receives at least one res distribution instruction, and the benefit allocator 204 distributes a portion of the res as specified by the res distribution instruction. The portion of the res to be distributed may be the entire res, in which case the distribution may coincide with the termination of the trust, as set forth below. The portion of the res may be less than the entire res; for instance, the portion may be some fraction less than one of the res. For example, in some embodiments, the res distribution instruction provides for the payment of property in the res to the at least one beneficiary in equal installments on regular dates throughout the life of the trust, subject to the evaluation of the at least one conduct condition. The portion of the res may be distributed to one beneficiary. The portion of the res may be distributed to multiple beneficiaries. The portion may be divided among the beneficiaries pro rata. The portion may be divided pursuant to beneficiary-specific instructions; for example, where part of the res is a house, the house may be conveyed to some subset of the beneficiaries who the settlor believes will benefit from the ability to live in the house at a certain point in time.

In some embodiments, the receiver 202 receives an instruction implementing a trust termination condition, and the evaluator 203 determines that the trust termination condition has occurred and terminates the trust. In embodiments wherein the receiver 202 also receives at least one res distribution instruction, terminating the trust may involve distributing the res as specified by the res distribution instruction. For instance, the trust may terminate upon a beneficiary failing some threshold number of conduct conditions. The trust may terminate upon a beneficiary failing a single conduct condition on a threshold number of occurrences. The trust may terminate upon the beneficiary failing a single conduct condition once. The termination instruction may specify that the res be distributed to an entity other than the beneficiary, such as a charitable institution. In other embodiments, the settlor specifies a particular course of conduct as demonstrating that a beneficiary has achieved sufficient maturity to control the res directly; for instance, the instruction may specify that if the at least one beneficiary satisfies the at least one conduct condition a certain number of consecutive times, the trust should be terminated, and the res distributed to the at least one beneficiary. Where there are multiple beneficiaries, termination and res distribution may occur with respect to one beneficiary while leaving the trust and remaining res in place for the others; for instance, when one beneficiary has demonstrated readiness to receive his or her portion of the trust property as described above, that beneficiary may receive his or her portion of the res, while the remaining beneficiaries remain in the trust as before. Conversely, the evaluator 203 may determine as above that one beneficiary should lose his or her rights in the trust property, and that beneficiary's portion of the res may be allocated to an alternate entity as provide above.

In some embodiments, the receiver 202 receives at least one trust income distribution instruction, and the benefit allocator 204 disburses a portion of the trust income as specified by the trust income distribution instruction. The portion of the trust income may be the entire trust income. The portion of the trust income may be less than the entire trust income; for instance, some of the trust income may be reinvested. In some embodiments, where the res is invested to generate income at a fixed rate, the benefit allocator 204 multiplies the fixed rate by the value of the res to derive the trust income. In other embodiments, the benefit allocator 204 receives information detailing the income generated from each entity overseeing the management of a portion of the res. Thus, for instance, the benefit allocator 204 may receive a report of income from a server 122 operated by an entity managing an investment portfolio in which a part of the res is invested. The benefit allocator 204 may receive a report entered by a person affiliated with the entity, via the client machine 120 that person operates. The benefit allocator 204 may receive a description of income generated by real property from a manager of that property. The benefit allocator 204 may add together the incomes generated from various parts of the res to determine the full trust income. In some embodiments, the benefit allocator 204 determines the net trust income, rather than the gross trust income, by subtracting from the gross income expenses incurred pursuant to the management of the trust. Expenses may include fees owed to a trustee. Expenses may include fees for professional service such as legal or investment advice. Where part of the res is real property, the expenses may include maintenance costs and property taxes.

In one embodiment, the receiver 202 receives an instruction that specifies what proportion of the trust income is to be disbursed, and the benefit allocator 204 disburses that proportion of the trust income. In some embodiments, the receiver 202 receives an instruction that specifies a fixed amount of trust income to be disbursed to the at least one beneficiary, and the benefit allocator 204 disburses that fixed amount. The portion of the trust income may be distributed to one beneficiary. The portion of the trust income may be distributed to multiple beneficiaries. The portion may be divided among the beneficiaries pro rata. The portion may be divided pursuant to beneficiary-specific instructions.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for automated conditional trust income disbursement, the method comprising:
receiving, by a computing device, at least one instruction implementing trust provisions including a res, at least one beneficiary, and at least one conduct condition;
determining, by the computing device, whether the at least one beneficiary has satisfied the at least one conduct condition; and
allocating, by the computing device, a benefit, responsive to the determination.

2. A method according to claim 1 wherein eceiving further comprises receiving an instruction identifying at least one account to which to allocate the benefit.

3. A method according to claim 1, wherein receiving further comprises receiving an instruction specifying a date for the allocation of the benefit.

4. A method according to claim 1, wherein receiving further comprises:
providing, to a settlor, a plurality of potential trust provisions with corresponding instructions; and
receiving, from the settlor, a selection of at least one of the plurality of potential trust provisions and a selection of the instruction corresponding to that at least one potential trust provision.

5. A method according to claim 1, wherein receiving further comprises:
receiving, from a settlor, textual data describing trust provisions; and
converting the textual data into at least one instruction.

6. A method according to claim 5, wherein receiving textual data further comprises:
receiving, from the settlor, a scanned document containing an image of at least one trust provision; and
extracting, from the scanned document, textual data describing trust provisions.

7. A method according to claim 1, wherein determining further comprises:
receiving data from the at least one beneficiary; and
comparing the received data to the at least one conduct condition.

8. A method according to claim 1, wherein determining further comprises:
receiving data from an additional computing device; and
comparing the received data to the at least one conduct condition.

9. A method according to claim 1, wherein determining further comprises determining that no data relevant to the conduct condition has been received.

10. A method according to claim 1, wherein determining further comprises determining that the at least one beneficiary has met the at least one conduct condition, and allocating further comprises automatically disbursing the benefit to the at least one beneficiary.

11. A method according to claim 10, wherein disbursing further comprises performing an electronic fund transfer to an account possessed by the at least one beneficiary.

12. A method according to claim 10, wherein disbursing further comprises:
printing a negotiable instrument; and
shipping the negotiable instrument to the at least one beneficiary.

13. A method according to claim 1, wherein determining further comprises determining that the at least one beneficiary has not met the at least one conduct condition, and wherein allocating the benefit further comprises disbursing the benefit to an alternate entity.

14. A method according to claim 1, wherein determining further comprises determining that the at least one beneficiary has not met the at least one conduct condition, and wherein allocating the benefit further comprises reinvesting trust income in the res.

15. A method according to claim 1, wherein receiving further comprises receiving at least one res distribution instruction, and allocating the benefit further comprises distributing a portion of the res as specified by the res distribution instruction.

16. A method according to claim 1, wherein receiving further comprises receiving an instruction implementing a trust termination condition, and further comprising:
determining that the trust termination condition has occurred; and
terminating the trust.

17. A method according to claim 1, wherein receiving further comprises receiving at least one trust income distribution instruction, and allocating the benefit further comprises disbursing a portion of trust income generated by the trust, as specified by the trust income distribution instruction.

18. A method according to claim 17, wherein receiving the at least one trust income distribution instruction further comprises receiving an instruction that specifies what proportion of the trust income is to be disbursed, and disbursing further comprises disbursing that proportion of the trust income.

19. A method according to claim 17, wherein receiving the at least one trust income distribution instruction further comprises receiving an instruction that specifies a fixed amount of the trust income to be disbursed, and disbursing further comprises disbursing that fixed amount.

20. A system for automated conditional trust income disbursement, the system comprising:
a computing device;
a receiver, executing on the computing device, and configured to receive at least one instruction implementing trust provisions including a res, at least one beneficiary, and at least one conduct condition;
an evaluator, executing on the computing device, and configured to determine whether the at least one beneficiary has satisfied the at least one conduct condition; and
a benefit allocator, executing on the computing device, and configured to allocate the trust income, responsive to the determination.
